(19) United States
(12) Patent Application Publication
(10) Pub. No.: US 2014/0034572 A1
(43) Pub. Date: Feb. 6, 2014

(54) METHODS AND SYSTEMS FOR MAINTAINING THE TEMPERATURE OF WASTEWATER IN A TREATMENT FACILITY

(71) Applicant: R N INDUSTRIES, INC., Roosevelt, UT (US)

(72) Inventor: Walter E. McAlister, JR., Rangely, CO (US)

(73) Assignee: R N INDUSTRIES, INC., Roosevelt, UT (US)

(21) Appl. No.: 13/955,430

(22) Filed: Jul. 31, 2013

Related U.S. Application Data
(60) Provisional application No. 61/677,998, filed on Jul. 31, 2012.

(51) Int. Cl. C02F 3/28

(52) U.S. Cl. CPC C02F 3/28
USPC 210/603; 210/150; 210/601; 210/610

(57) ABSTRACT

Volatile organic compounds (VOCs), such as benzene, toluene, ethylbenzene, xylene and methanol may be removed from wastewater obtained from oil or gas exploration or production operations by way of a bioreactor. The bioreactor may employ anaerobic microorganisms that metabolize various VOCs. In some embodiments, such a bioreactor may be configured to selectively change the temperature of the conditions of wastewater placed in the bioreactor, or of wastewater re-circulated through the bioreactor. A centralized valving or control station may optionally control heating or other conditioning elements for both feed and re-circulation systems.

### CROSS-REFERENCE TO RELATED APPLICATIONS

A claim for priority is hereby made pursuant to 35 U.S.C. §119(e) to U.S. Provisional Patent Application No. 61/677,998, filed Jul. 31, 2012, and titled METHODS AND SYSTEMS FOR MAINTAINING THE TEMPERATURE OF WASTEWATER IN A TREATMENT FACILITY (“the '998 Provisional Application”) is hereby made. The entire disclosure of the '998 Provisional Application is expressly incorporated herein by this reference.

### TECHNICAL FIELD

This disclosure relates generally to the treatment of wastewater. More specifically, this disclosure relates to methods and systems for maintaining favorable environmental conditions for anaerobic digestion of volatile organic compounds (VOCs) within wastewater. More particularly still, this disclosure relates to methods and systems that mix contents of a bioreactor, or digester and/or which maintain the contents at a desired temperature that promotes digestion of VOCs.

### RELATED ART

Wastewater is a byproduct of many different manufacturing, agricultural, oil and gas exploration and production (E&P), and other industries. For instance, a manufacturing facility may use cutting fluid when milling, turning or otherwise forming different mechanical components. Some cutting fluid may be recovered; however, other cutting fluid may be mixed with water making it unsuitable for use as a cutting fluid as well as for consumption or other use.

Similarly, water is often present with oil or gas in oil and gas reservoirs. Thus, when oil and gas are extracted from a well, water is also usually present. This is particularly the case as a well is depleted. As the density of water is greater than that of oil or gas, water tends to be located near the bottom of the well, and more and more naturally occurring water is then extracted upon depletion of the well.

In E&P processes, water may also be introduced into a well and thereafter removed with oil or gas from the well. Among other purposes, water may be introduced into a well in a process known as “flooding” to displace oil or gas within the well. Water may be injected into a well to increase pressure within the well and to thereby stimulate the well to maximize its production of oil or gas, a technique that is known in the art as “hydraulic fracturing.” Like naturally occurring water, water that has been introduced into a well accompanies oil or gas out of the well. Depending upon its original source, the water that is removed from the ground along with oil or gas is known in the art as “flow-back water” (for water introduced into and subsequently removed from the well) or as “produced water” (for water that was already present within the well). Water that is removed from an oil or gas well is considered to be E&P waste.

Whether wastewater is produced in E&P waste, or is part of agricultural, mechanical, or other processes, the wastewater can include any number of different hazardous air pollutants (HAPs), including volatile organic compounds (VOCs). Example VOCs include the so-called “BTEX” materials (i.e., benzene, toluene, ethylbenzene and xylene). In addition, in colder environments, methanol (CH₃OH), another HAP, may be used as an antifreeze (e.g., and introduced into a well or used in another process). The methanol may mix with water and also be present in wastewater.

Various processes have been used to treat wastewater to neutralize and/or remove HAPs. Conventionally, wastewater has been transported to a water treatment, or remediation, facility. At such a location, phase (i.e., oil and water) separable hydrocarbons and sludge are removed from the wastewater before disposing of the wastewater. One of the more cost-efficient methods for disposing of E&P wastewater, for instance, employs evaporation ponds. From an evaporation pond, the E&P wastewater may be introduced back into the environment (e.g., into the atmosphere, into ground water, etc.), along with a portion of the HAPs originally dissolved in the wastewater. From an environmental perspective, the placement of E&P wastewater that includes dissolved HAPs into evaporation ponds is less desirable than other, more expensive disposal methods.

To enhance the removal of undissolved VOCs, the Environmental Protection Agency (EPA) and analogous agencies have implemented environmental regulations requiring that wastewater be treated before it may be placed into evaporation ponds. Under such regulations, the wastewater may be passed through various filters, enhanced gravity separation, emulsification removers, chemical treatment and other advanced treatment devices. Some treatments may also include using anaerobic bacteria that metabolizes dissolved VOCs and other HAPs, and converts them into other more products (e.g., carbon dioxide or methane gas) that can be more easily removed from the wastewater. The anaerobic bacteria may be sensitive to various changes in the environment. For instance, during winter months when temperatures decrease, the wastewater naturally cools. When cooled, the anaerobic bacteria operate more slowly, and thus metabolize less of the VOCs and produce less gas byproduct. Thus, the wastewater has to be treated longer, or is released into evaporation ponds despite significant amounts of dissolved VOCs remaining in the treated water. The wastewater may thus potentially pollute the atmosphere and ground water.

### SUMMARY

This disclosure relates to the treatment of E&P wastewater, which is also referred to herein as “wastewater,” recovered from oil and gas exploration and production sites. In addition to being useful for treating E&P wastewater, the apparatuses, systems and methods disclosed herein may be used to treat wastewater from other sources (e.g., manufacturing, agricultural, consumer, commercial, etc.). More specifically, apparatuses, systems, facilities and methods for removing dissolved volatile organic compounds (VOCs), which are widely considered to be hazardous air pollutants (HAPs), from wastewater. The various VOCs that may be removed from wastewater include, but are not limited to, methanol (i.e., methyl alcohol) and the so-called “BTEX” materials (i.e., benzene, toluene, ethylbenzene and xylene). These materials may be safely removed from wastewater and converted to less harmful substances (e.g., carbon dioxide (CO₂), water vapor, methane (CH₄), etc.) by anaerobic bacteria or other microorganisms.

In one aspect, a system includes a vessel operating as a bioreactor, or digester, for treating wastewater. The bioreactor or systems associated therewith may provide a favorable environment for anaerobic microorganisms. In addition, the bioreactor may include one or more elements for continually or occasionally re-circulating the contents of the bioreactor, including the anaerobic microorganisms and any wastewater within the vessel. The bioreactor vessel may take a variety of configurations, depending at least in part upon the volume of wastewater to be treated and the location where the wastewater is to be treated. Where relatively small volumes of wastewater are to be treated (e.g., on the order of hundreds of barrels, 500 barrels or less, etc.), the bioreactor vessel may comprise a tank, such as a frac tank of the type commonly used in the oil and gas industry. When larger volumes of wastewater are to be treated, the bioreactor vessel may comprise a pool, pond or other fluid constructed for this purpose at a wastewater treatment facility.

The anaerobic microorganisms of a bioreactor are selected to metabolize, or digest, various VOCs that have dissolved in the wastewater, including methanol and the BTEX materials, while withstanding the harsh conditions that are typically present in wastewater from oil and gas exploration or production (e.g., the VOCs, other pollutants, etc.) or other processes. The ability of the anaerobic microorganisms to metabolize VOCs may be optimized and maintained by carefully monitoring and controlling various conditions within the bioreactor vessel.

In one aspect, this disclosure relates to systems for treating wastewater. In addition to a bioreactor vessel, such a system includes a variety of other elements, including components for controlling and maintaining desired conditions within the bioreactor vessel, and components for providing wastewater to the bioreactor vessel. In accordance with one illustrative example, a vessel containing untreated wastewater may provide the untreated wastewater to the bioreactor vessel. A valving station that includes one or more conditioning elements may be used to adjust the conditions of the feed wastewater to maintain wastewater in the bioreactor vessel at desired conditions. Valves and other elements in the valving station may be used to select which conditioning elements are to be used, although, if desired conditions are already present, the valves may allow the feed wastewater to bypass one or more conditioning elements.

An example system for maintaining desired conditions may include one or more pressure elements (e.g., pumps, gravity feed systems, etc.) for conveying wastewater from the feed vessel to the bioreactor vessel. If a condition (e.g., temperature, etc.) of the wastewater is outside of a desired range (e.g., too high or too low), a valving station that is downstream from the feed vessel and upstream from the bioreactor vessel may cause the feed wastewater to be heated, cooled, or otherwise conditioned so as to obtain conditions that match those of the bioreactor vessel, or can be used to change the conditions in the bioreactor to a desired level. Thus, if the feed water is colder than is optimal for anaerobic microorganisms to metabolize VOCs, the feed water may be heated to a desired level. Similarly, if the temperature of wastewater in a bioreactor is colder than desired, feed water can be heated so as to raise the entire temperature within the bioreactor vessel. The desired temperature can thus be maintained by controlling when and to what degree temperature or other conditions of the feed water are changed.

Another example system may maintain desired conditions through use of a re-circulation system connected to, or included within, the bioreactor vessel. An outlet may take wastewater, sludge or other materials from the bioreactor vessel, move them, and re-introduce them into the bioreactor vessel (or a portion thereof). The re-circulation may mix the anaerobic microorganisms to redistribute them throughout the wastewater. Such redistribution may allow the anaerobic microorganisms to operate more efficiently in the breakdown of the wastewater.

Re-circulation may thus be used to maintain desired conditions within a bioreactor system. Re-circulation may be controlled using a valving station. Using the valving station, one or more types of materials (e.g., wastewater, sludge, anaerobic microorganisms) may be removed and re-circulated to enhance operation. Valves may control which types of materials are removed and how they are mixed together. In accordance with some aspects, the valving station may use a heating or other conditioning element to further maintain desired conditions. If wastewater in the bioreactor vessel is, for instance, too cold for optimal performance of the anaerobic microorganisms, valves may be opened or closed as necessary to direct the re-circulated materials through a heater to raise them to a desired level (e.g., the temperature at which optimal performance is obtained, an above-desired temperature to mix with the contents of the bioreactor vessel and increase the temperature within the full vessel to a desired level, etc.). When a desired temperature is present, the valving station may close valves to the heating element, thereby bypassing the heating element and merely re-circulating the removed materials.

Some embodiments of the present disclosure contemplate a bioreactor system that maintains desired conditions by controlling feeding, re-circulation and heating. Optionally, a central valving station may be used to both feed wastewater to a bioreactor vessel and to re-circulate materials within the bioreactor vessel. Separate pumps, gravity feed mechanisms, or the like may be used for feeding and re-circulating, or all or some aspects of feeding and re-circulating wastewater may be combined into operation of a pump or other device. A heating element for heating transferred fluid may be used in connection with a set of one or more valves. Thus, as the temperature of feed or re-circulated water is too low, the valving station may direct the corresponding wastewater to the heating element. In contrast, if the temperature is suitable, the valving station may direct the wastewater to bypass the heating element. Centralized control may be provided by a valving station for any or all aspects related to controlling conditions of a bioreactor system, including feeding, mixing, re-circulating, draining, etc. the bioreactor vessel.

A valving station of some embodiments may be used regardless of whether the bioreactor system is a large-scale system including a bioreactor pond fed from a skim pond, or in a smaller-scale, and even portable system.

Methods for treating wastewater and maintaining wastewater at a desired temperature or other condition are also disclosed. Broadly, such a method includes isolating wastewater from hydrocarbons and solid materials (i.e., sludge) and removing VOCs from the wastewater. By controlling the conditions of the wastewater, dissolved VOCs may be metabolized by anaerobic bacteria in an optimized manner and removed from the wastewater.

In a specific embodiment for treating wastewater and maintaining the wastewater at a desired temperature, untreated wastewater is accessed from a feed reservoir. The untreated wastewater is transferred to a bioreactor reservoir for mixing with treated wastewater and anaerobic microorganisms. The treated and/or untreated wastewater may be conditioned. For instance, when the untreated wastewater is conditioned, the untreated wastewater may be selectively transferred to a heater or other conditioning element after being output from the feed reservoir and prior to being input to the bioreactor reservoir. When the treated wastewater is being conditioned, the treated wastewater may be re-circulated and selectively transferred to the conditioning element and thereafter re-input into the bioreactor reservoir. The untreated wastewater can then be treated with the anaerobic microorganisms to reduce a content of volatile organic compounds dissolved in the untreated wastewater.

Other aspects, as well as features and advantages of various aspects, of the disclosed subject matter will become apparent to those of ordinary skill in the art through consideration of the ensuing description, the accompanying drawings and the appended claims

### BRIEF DESCRIPTION OF THE DRAWINGS

In the drawings:

FIG. 1 schematically illustrates an embodiment of a bioreactor system for maintaining desired conditions within wastewater in which VOCs are being removed;

FIG. 2 is a cross-sectional view of an embodiment of a large-scale bioreactor system of a wastewater treatment site, the bioreactor system including a valving system for maintaining favorable conditions within treated wastewater;

FIG. 3 is a schematic representation of a bioreactor system having a valving station between feed and bioreactor reservoirs, the valving station including valves and a heating element for selectively heating feed wastewater and/or re-circulated wastewater; and

FIG. 4 is a schematic representation of another bioreactor system having a valving station for selectively heating feed wastewater and/or re-circulated wastewater.

### DETAILED DESCRIPTION

According to one aspect of this disclosure, a properly configured bioreactor may be configured to remove volatile organic compounds (VOCs) and other hazardous air pollutants (HAPs) present in wastewater from the wastewater. The wastewater may originate from any number of sources, including from an oil or gas well in connection with oil exploration and production (E&P) systems, from agricultural systems, from domestic or residential properties, or from other sources or any combination of the foregoing.

In various embodiments, a bioreactor system may include a feed vessel and a reactor vessel. Generally speaking, wastewater may be contained in the feed vessel may be provided to the reactor vessel where anaerobic microorganisms (e.g., anaerobic bacteria) metabolize the organic compounds in wastewater, including but not limited to VOCs and/or other HAPs. In the same or other embodiments, the bioreactor system may include a reactant optimization system for maintaining favorable environmental conditions within wastewater treated within, or fed to, the reactor vessel. The reactant optimization system may include heating and/or mixing components which may be used to maintain the wastewater at a favorable temperature and/or distribute anaerobic microorganisms throughout the wastewater in the bioreactor vessel. A bioreactor system may also include an outlet from which produced biogas may be collected.

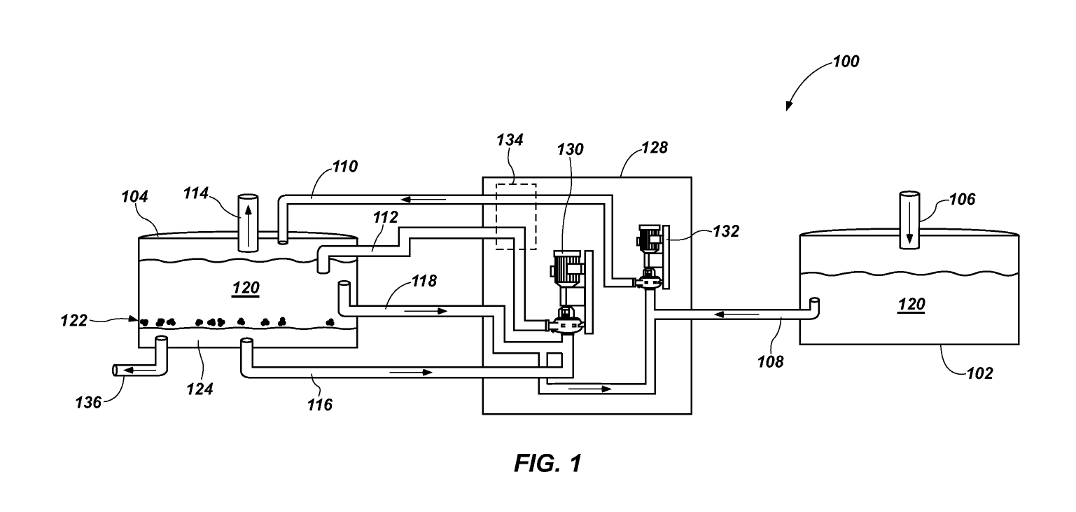

As shown in FIG. 1, a bioreactor system 100 may include one or more fluid reservoirs 102, 104. The reservoirs 102, 104 may be tanks or other vessels capable of selectively holding a fluid. For simplicity, the fluid reservoirs 102, 104 may each be referred to herein as a “tank”, although the fluid reservoirs 102, 104 are not limited to any particular structure or form.

According to some embodiments, the tank 102 may be a feed vessel which stores or otherwise holds wastewater that is fed or otherwise provided to the tank 104. The tank 102 may include an inlet 106 to the interior thereof, as well as one or more outlets 108. In this particular embodiment, an inlet 106 may allow wastewater 120 or other fluids to be placed within the interior of the tank 102. The outlet 108 may lead to an exterior of the tank 102. Such an outlet 108 may allow the tank 102 to be drained or otherwise allow the wastewater 120 to be expelled from the tank 102. In at least some embodiments, the outlet 108 may facilitate moving of wastewater 120 from the tank 102 to or towards the tank 104.

The tank 104 may also have wastewater 120 therein. One or more inlets 110, 112 may be used to move the wastewater 120 into or through the tank 104. In this particular embodiment, the tank 104 includes two inlets 110, 112, although any number of inlets may be provided. According to some embodiments of the present disclosure, wastewater 120 within the tank 102 may be placed within the tank 104 through at least the inlet 110.

According to some embodiments of the present disclosure, the tank 104 may also be a bioreactor, or digester, which contains anaerobic microorganisms 122. The anaerobic microorganisms 122 may comprise one or more different microorganisms (e.g., bacteria, etc.) that metabolize the various VOCs (e.g., the BTEX materials, methanol, etc.) and, optionally, other HAPs that may be present within the wastewater 120. VOCs may be constantly contained to prevent their introduction into the environment and, therefore, provided little or no elemental oxygen (O₂) at the surface of the wastewater 120. Consequently, the microorganisms that are used to metabolize the VOCs may be able to live with little or no oxygen (i.e., they are anaerobic). As different microorganisms may metabolize one or more types of VOCs, but not all of the different types of VOCs that are typically present in wastewater 120, the anaerobic microorganisms 122 that are used in the bioreactor system 100 may include a mixture of different microorganisms. In a specific embodiment, the anaerobic microorganisms 122 comprise a mixture of microorganisms from wastewater treatment sites with sludge having a high total dissolved solids (TDS) content (e.g., a TDS content of about 1,500 mg/L or more, a TDS content of about 2,500 mg/L, etc.). In some embodiments, the anaerobic microorganisms 122 may be acclimated to withstand a TDS content of up to about 20,000 mg/L, up to about 25,000 mg/L, or more.

As the wastewater 120 is in the tank 104, the various components and materials may separate. For instance, solid materials (sludge) 124 may have a higher density than the liquid wastewater 120, and may fall to the bottom of the tank 104. The anaerobic microorganisms 122 can interact with the organic materials within the wastewater 120 and/or sludge 124 to break-down the organic materials. Optionally, the anaerobic microorganisms 122 produce a gas byproduct. An outlet 114 may be located near a top of the tank 104 to enable the removal of such gases (e.g., methane, etc.) which are produced during the treatment of the wastewater 120 (e.g., the metabolism of VOCs by the anaerobic bacteria 122, etc.) in the tank 104, enabling pressure that builds within the tank 104 to be periodically released and potentially collected.

In accordance with various embodiments, the wastewater 120 and/or solid materials/sludge 124 may be moved or mixed. In such a process, the anaerobic microorganisms 122 may also be moved and redistributed throughout the wastewater 120. Such redistribution may allow the anaerobic microorganisms 122 to operate more efficiently in the breakdown of the wastewater 120 and/or the production of the gas byproduct.

Movement of the wastewater 120, sludge 124, microorganisms 122, or any combination thereof, may be accomplished in any suitable manner. In some embodiments, for instance, an agitator, mixer, sparger, or other device may be positioned within the tank 104 and used to move and mix the contents within the tank 104. In the same or other embodiments, materials may be moved out of the tank 104 and then re-introduced into the tank 104. Such movement can create a flow that mixes the materials within the tank 104. FIG. 1 illustrates an example of such a system 100, and includes a valving station 128 that can be used to facilitate the flow of materials in and out of the tank 104.

More particularly, the tank 104 of this illustrative example includes two outlets 116, 118 enabling removal of substances from the interior of the tank 104 and their communication to locations outside of the tank 104. As illustrated, one of the outlets (i.e., outlet 118 in the illustrated embodiment) may be located near a top of the tank 104 so as to enable clarification of the wastewater 120 (e.g., by gravity, etc.) as the wastewater 120 is removed from the tank 104, leaving some or all of the solid materials 124, sludge and the anaerobic bacteria 122 within the interior of the tank 104. Physical structures such as filters, baffles, and the like may also be provided to create a physical barrier between portions of the interior of the tank 102 and the outlet 118 to enable clarification of wastewater 120 exiting the interior of the tank 104.

An outlet 116 may, in contrast, be positioned at or near a bottom of the interior of the tank 104, and lower relative to the outlet 118 which removes the wastewater 120. Sludge or other solid materials 124 that are left behind and sink to the bottom of the tank 104 may be removed through the outlet 116. Valves, including valves associated with the valving station 128, may be used to control movement of the solid materials 124 through the outlet 116.

Removal of liquids, sludge, or other materials from the tank 104 may be performed in any suitable manner. For instance, a valve may be associated with each of the inlets and the outlets of the tanks 102, 104 to control the movement of fluids into or out of the tanks 102, 104. Such valves may be located at or near the tanks 102, 104 and/or in other locations. As shown in FIG. 1, for instance, the valving station 128 may include one or more pumps 130, 132. Such pumps 130, 132 may be pressure elements that can create suction to remove the wastewater 120, microorganisms 122, solid materials 124, or other materials or any combination thereof. Valves (not shown) may be used and opened and closed to determine when a pump 130, 132 draws from a particular tank 102, 104.

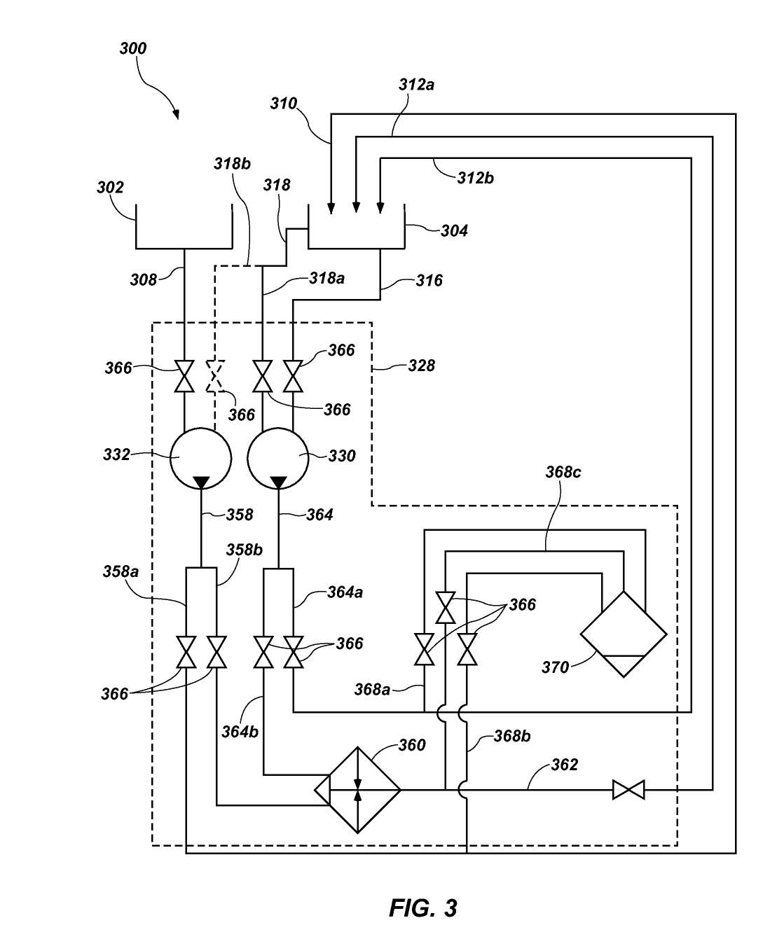

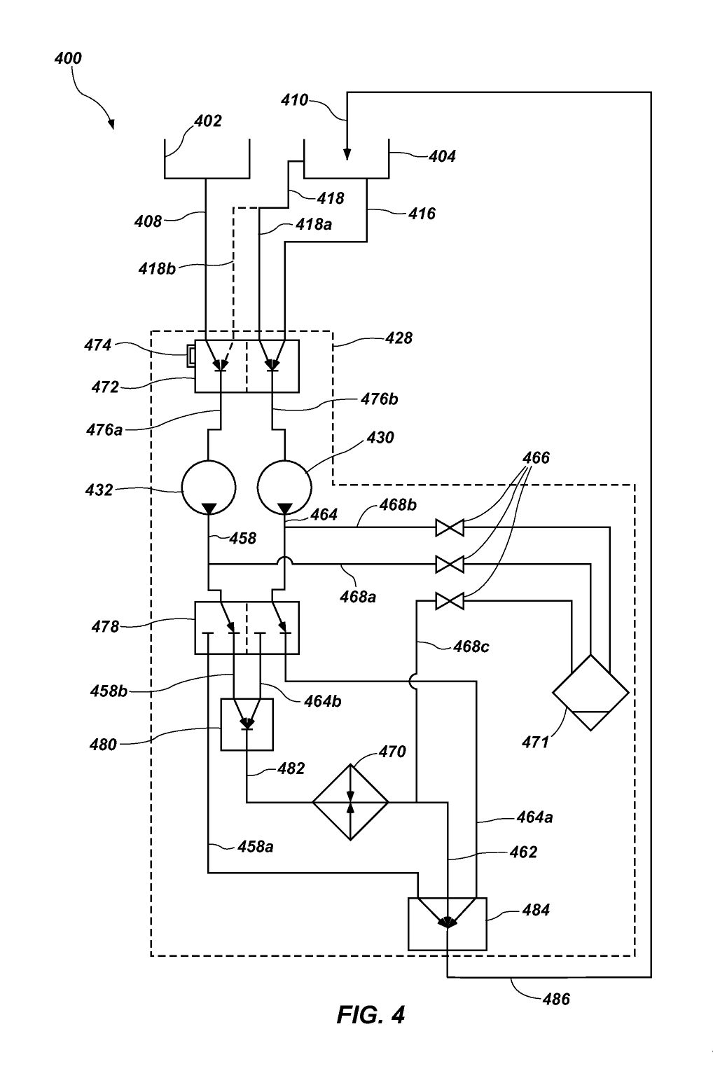

Examples of valving stations are described in greater detail hereafter, and particularly with respect to FIGS. 3 and 4. The valving station 128 may, however, have any suitable configuration and is not limited to that illustrated or those shown in FIGS. 3 and 4.

As shown in FIG. 1, an example valving station 128 may allow materials to be removed through the outlets 116, 118, whether by using the pumps 130, 132 or other mechanisms. The removed materials may be removed from the tank 104, routed through the valving station 128, and back into the tank 104 through one or more inlets 110, 112. Such a configuration may re-circulate materials as described above. Optionally, the outlets 116, 118 may direct materials into a single pump (e.g., pump 130). Alternatively, multiple pumps (e.g., pump 130, 132) may be used for all or portions of the materials removed from the tank 104. Moreover, one or both of the pumps 130, 132 may also or alternatively be used to assist in moving wastewater or other materials from the tank 102 to the tank 104. The valving station 128 may thus assist the tank 102 in acting as a feed tank for providing wastewater to the tank 104 which operates as a bioreactor, or digester.

Although the illustrated embodiment shows a valving station 128 with a set of pumps 130, 132, it should be appreciated in view of the disclosure herein that any suitable manner for moving the materials into and/or out of the tanks 102, 104 may be used. In other example embodiments, for instance, pump may be replaced or supplemented by another pressure element, including a gravity feed or other alternative system, or any combination thereof.

The valving station 128 may also include one or more optional components. Shown in FIG. 1, for instance, materials output from the pumps 130, 132 may pass through an additional component 134. The additional component can take any suitable form. By way of illustration, the component 134 may include a heating element configured to heat fluid entering the tank 104 from the tank 102 or being re-circulated through the tank 104. In another embodiment, the component 134 may include a filter or additive station. A filter may remove certain components from the pumped materials while an additive station may add certain components. By way of example, the additive station may be used to add anaerobic microorganisms into the tank 104. In other embodiments, methanol may be added. Methanol may, for instance, act as a stabilizer or catalyst to improve the efficiency or speed of anaerobic microorganisms in breaking down the VOCs or other HAPs within the tank 104. Of course, the component 134 may also include other elements, including burner, clarifier, chiller, or the like. Any combination of such elements may also be used.

Although the output of the pumps 130, 132 are shown as each passing through the component 134, such an embodiment is merely illustrative. In other embodiments, one or both outputs may bypass the component 134. In still other embodiments, outputs from one or both of the pumps 130, 132 may selectively bypass the component 134.

The system 100 may include additional or other components, subsystems, devices or elements in addition to, or instead of, those described. FIG. 1, for instance, illustrates an outlet 136 for the tank 104, which outlet 136 may be used to drain the tank 104 or otherwise remove material therefrom. In accordance with some example embodiments, the outlet 136 may allow materials to be removed from the tank 104 and moved to another location where the wastewater 120 and/or sludge 124 may be provided to additional tanks, ponds, vessels, or devices that filter, dry, burn, treat or otherwise process the wastewater 120 and/or sludge 124. The outlet 136 may also have a valve (not shown) which may be separate from, or included with, the valving station 128.

FIG. 1 illustrates an example system that may generally represent any number of different types of bioreactor systems. In one embodiment, the bioreactor system 100 may encompass a small-scale system. In such a system, tanks 102, 104 may have a relatively small size, and can, by way of example, have a volume on the order of one barrel to thousands of barrels. As a more particular example, the tanks 102, 104 may have a volume between about one hundred barrels and about a thousand barrels. More particularly still, an example embodiment may include a so-called “frac tank” of a type commonly used in the oil and gas industry, the volume of which may be between about 300 barrels and about 500 barrels (e.g., 400 barrels).

Because of its size, the bioreactor system 100 shown in FIG. 1 may be relatively portable (e.g., be transported on a trailer; comprise part of a tanker, such as a tanker trailer or tanker truck; etc.). The portability of a bioreactor system 100, or its components, may enable wastewater 120 or other wastewater that includes dissolved VOCs to be treated at or near the site from which such water is obtained. In other embodiments, wastewater 120 may be treated at a location remote from the location where it is obtained, or the tanks 102, 104 may be difficult or impossible to transport. More particularly still, some embodiments of the tanks 102, 104 contemplate use of the bioreactor system 100 on a larger scale, such as where the tanks 102, 104 may represent fluid reservoirs such as ponds.

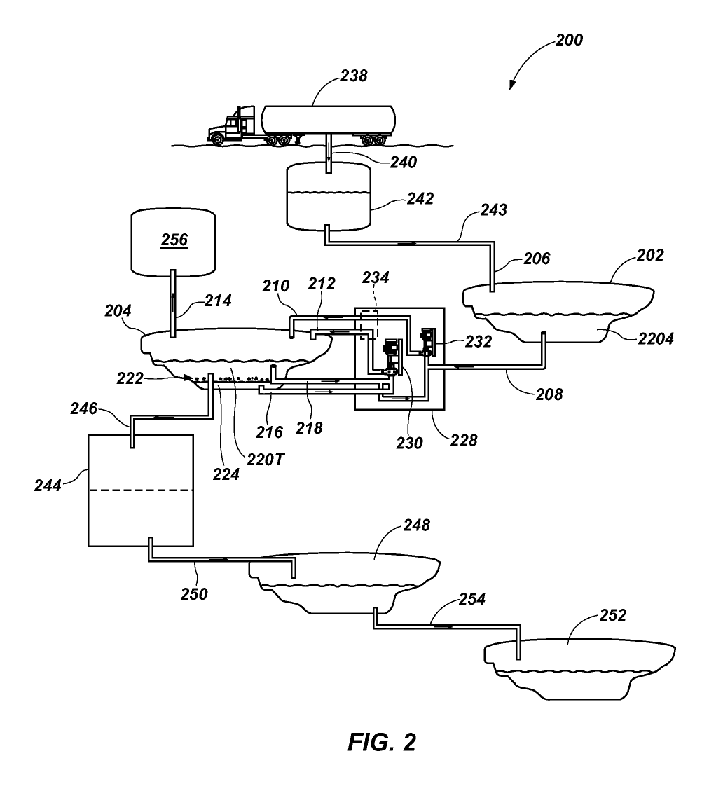

Turning now to FIG. 2 an embodiment of a water treatment site is illustrated and includes a bioreactor system 200 configured for the large scale treatment of wastewater. Like a smaller version that may be represented by the bioreactor system 100 shown in FIG. 1, the bioreactor system 200 includes a fluid reservoir 202 having an inlet 206 and an outlet 208. Moreover, the bioreactor system 200 also includes a fluid reservoir 204, which can act as a bioreactor, and which includes a set of inlets 210, 212 and outlets 214-218. The fluid reservoir 204 may act as a large-scale bioreactor configured to collect large amounts of water (e.g., wastewater, etc.). Such collection may occur on a substantially continually basis. An example fluid reservoir 204 could potentially process a thousand or more barrels of wastewater each day.

The bioreactor system 200 also includes anaerobic microorganisms 222 for treating water within the interior of the reservoir 204. In addition, the bioreactor system 220 may include other components that interact with the fluid reservoir 204, including a sludge collection system that communicates with the outlet 218 and/or the bottom of the reservoir 204, a mixing system, a leak detection system, a valving system 228, or any combination of the foregoing. Embodiments of some of these additional components are described in additional detail in U.S. patent application Ser. No. 61/677,004, filed on Jul. 30, 2012, which application is hereby expressly incorporated herein by this reference in its entirety.

The illustrated valving system 228 may also be similar to the valving station 128 represented in FIG. 1. Thus, the illustrated valving system includes a set of pumps 230, 232 that communicate with inlets 210, 212 and outlets 216, 218 of the bioreactor reservoir 204 and with the outlet 208 of the feed reservoir 202. Such components may allow the transport of untreated wastewater 220U to the bioreactor reservoir 204, as well as the re-circulation of treated wastewater 220T in the bioreactor reservoir 204. Untreated or treated wastewater may also be heated, cooled, or otherwise conditioned (e.g., to maintain the treated wastewater 220T at a desired temperature) using a conditioning element 234 of the valving station 228.

Various parameters, such as the amount of pressure generated by the pumps 230, 232, the orientations and locations of the outlets 216, 218 and the inlets 210, 212, may dictate the manner in which fluids move through (e.g., are circulated within, etc.) the interior of the bioreactor reservoir 204. Such movement may homogenize the contents of the treated wastewater 220U and facilitate (e.g., increase the rate of, etc.) removal of VOCs from the wastewater.

The anaerobic microorganisms 224 of the bioreactor reservoir 204 may also have characteristics that are the same as or similar to the anaerobic microorganisms 122 of the bioreactor reservoir 104 described in reference to FIG. 1. For example, the anaerobic microorganisms 122, 222 may reduce levels of dissolved VOCs, such as the BTEX materials, in wastewater, including in wastewater collected during oil or gas exploration or production operations.

Because the bioreactor system 200 is large, the reservoirs 202, 204 may also be large. In various embodiments, the fluid reservoirs 202, 204 of a large bioreactor may comprise a pool or, as depicted, a pond. For simplicity, the fluid reservoirs 202, 204 may each be referred to herein as a “pond”, although the fluid reservoirs 202, 204 are not limited to any particular structure or form.

A pond, which may comprise a recessed area formed in the ground, may be constructed to have any desired capacity. Without limitation, one or both of the ponds 202, 204 may have a capacity of one thousand barrels or more. In some embodiments, the volume of the ponds 202, 204 may be ten thousand barrels or more, or even fifty thousand barrels or more (e.g., fifty-five thousand barrels). While various configurations of ponds 202, 204 are within the scope of this disclosure, relatively shallow ponds with relatively large surface areas may be used in some embodiments, as larger surface areas may support more of the anaerobic bacteria 224 of the bioreactor pond 204. Optionally, the ponds 202, 204 may have a liner or barrier (not shown) to prevent dissolved VOCs or other potential pollutants in the wastewater from seeping into the ground in which the ponds 202, 204 are located. Similarly, a cover (not shown) may also be placed over the ponds 202, 204 to restrict VOCs or other pollutants from escaping into the atmosphere.

As shown in FIG. 2, the bioreactor system 200 may include a number of additional reservoirs, including additional or other ponds, tanks, or the like. The bioreactor system 200 may operate as a full-scale wastewater treatment facility or wastewater treatment site. In such an embodiment, untreated wastewater 220U obtained from whatever source may be transported to the facility. In FIG. 2, the wastewater 220U may be transported using a tanker 238. A hose or other conduit on the tanker 238 may couple to a fitting leading to an inlet 240 to a fluid reservoir 242. In embodiments where the untreated wastewater 220U is transported from another component of a system or site where the bioreactor pond 204 is located, the inlet 240 may comprise a channel or a conduit that enables the untreated wastewater 220U to flow from an upstream location to reservoir 242.

The reservoir 242 may have any number of different structures or purposes. For instance, the reservoir 242 may be a storage tank, vault or separator. A vault or separator may perform some initial separation of wastewater from hydrocarbons and sludge. Untreated wastewater 220U from the reservoir 242 may also or instead be directed to another reservoir, such as the feed pond 202. The feed pond 202 may also be a so-called “skim pond” which further facilitates some separation of wastewater from hydrocarbons and/or sludge, as described in greater detail hereafter. Separated wastewater may then be transferred out of the outlet 208 and to the bioreactor pond 204, optionally with the assistance of the valving system 228.

In accordance with some embodiments of the present disclosure, the reservoir 242 may act as a separator holding several hundred, or even a thousand or more, barrels of liquid. Wastewater may be accompanied by light non-aqueous phase liquids (LNAPLs) (e.g., hydrocarbons, etc.) and dense non-aqueous phase liquids (DNAPLs) (e.g., paraffins, etc.), solid materials (i.e., sludge), and the like. The reservoir 242 may be the first component of the water treatment site where wastewater is processed. Specifically, the reservoir 242 may act as a separator configured to receive wastewater and to hold the wastewater for a sufficient period of time to enable the LNAPLs, water and sludge to separate. In some embodiments, the reservoir 242 is positioned at a location accessible to large trucks and tractor-trailers such as the tanker 238. The reservoir 242 may also be positioned at a higher elevation than other downstream components in order to facilitate flow of wastewater 120 through the water treatment site.

Wastewater 220 may be communicated from the reservoir 242 to the feed pond 202 through a pipe, hose or other conduit 243, and optionally one or more valves (e.g., valves in or separate from the valving system 228). At the feed pond 202, which may be acting as a skim pond, further separation of residual LNAPLs (e.g., hydrocarbons, etc.) and sludge (e.g., DNAPLs, solids, etc.) from the water may be achieved. The feed pond 202 may be significantly larger than a reservoir 242 acting as a separator. Thus, the wastewater may reside in the feed pond 202 for a much longer period of time than it may reside within the reservoir 242, without disrupting the rate at which wastewater may be delivered to and treated by the wastewater treatment site. The skim pond 202 may, in some embodiments, have a capacity of 10,000 barrels or more (e.g., 50,000 barrels, 80,000 barrels, 100,000 barrels, etc.).

Since the primary purpose of a skim pond is to enable further separation of LNAPLs, such as hydrocarbons, and sludge from the wastewater, hydrocarbon and sludge collection systems may also be associated with the feed pond 202. LNAPLs may be removed from the feed pond 202 in any suitable manner. As an example, an auto-skimmer of known type may be used to remove LNAPLs from the surface of the wastewater. As another example, LNAPLs may be separated from wastewater at an outlet of the feed pond 202. Any LNAPLs collected from the feed pond may be placed in a collection tank and, ultimately, transported to a storage tank where the LNAPLs will be stored until sufficient volumes are collected to justify their transportation from the water treatment site to a refinery.

After separation in the feed tank 202, untreated wastewater 220U may be removed therefrom through an outlet 208 of the feed pond 202. In the depicted embodiment, one or more valves or components of a valving system 228 may control the flow of untreated wastewater 220U out of the feed pond 202 to downstream locations, including to an inlet 210 of the bioreactor pond 204. In the bioreactor pond 204, untreated wastewater 220U may be treated using anaerobic microorganisms that digest VOCs and other materials and convert them into less harmful substances (e.g., carbon dioxide, water vapor, and methane).

Following treatment in the bioreactor pond 204, the wastewater may be treated wastewater 220T that can be transferred from the bioreactor pond 204 to still another component 244. An outlet 246 of the pond 204 enables treated wastewater 220T to be removed from the interior of the bioreactor pond 204. The component 244 to which the treated wastewater 220T is directed may have any number of different purposes or include different elements, including hydrocarbon removal components, storage tanks, burners, filters, and the like. For instance, the component 244 may be a filter configured to remove at least some HAPs, including some VOCs, from the water. Without limitation, the component 242 may be a filter configured to remove some toluene, ethylbenzene and xylene from the treated wastewater 220T. Treated wastewater 220T may also, in other embodiments, be allowed to bypass the filter or other component 242. In still further embodiments, the component 242 acts as a clarifier to remove sludge from treated wastewater 220T, which sludge may optionally be conveyed back to the bioreactor pond 204.

From the component 244, the treated wastewater 220T may further be conveyed to other locations, including to one or more evaporation ponds 248, 252 using outlets 250, 254. Each evaporation pond 248, 252 may be located at a lower elevation than the bioreactor pond 204 and/or the filter or other component 242, and may be configured in a manner known in the art. In embodiments where a wastewater treatment site includes a plurality of evaporation ponds 248, 252, each evaporation pond may be located at a lower elevation than the preceding pond. In order, upstream to downstream, the LNAPL content in wastewater decreases from one evaporation pond to the next, while the content of TDSs, including salt, in the water increases. More specifically, each evaporation pond 248, 252 may be configured to receive wastewater with reduced, environmentally acceptable levels of dissolved VOCs, or “treated water,” and to gradually introduce the treated water back into the environment (e.g., through evaporation into the air or reintroduction into surface water), after the water complies with governmental regulations.

When the component 242 and evaporation ponds 248, 252 are located at progressively lower elevations, the outlets 246, 250, 254 may exploit the use of gravity to move water therebetween, and can use one or more valves to control such a flow. The valves may, but need not necessarily, be part of the valving system 228. In other embodiments, pumps, whether or not part of the valving system 228, may enable the treated wastewater 220T to be removed from the bioreactor pond 204 and/or transported through successive downstream components. Combinations of gravity feed and pump systems may also be used.

The outlet 246 may comprise a channel or conduit that enables the treated wastewater 220T to flow to the downstream filter or other component 244. Optionally, the outlet 246 may be located at or near the bottom of the pond 204 and extend to a location at or near the top of the component 244. In such an embodiment, the configuration and/or orientation of the liquid outlet 246 may clarify the treated wastewater 220T as it is removed from the bioreactor pond 204. Outlet 250 between the component 244 and the evaporation pond 248 and/or the outlet 254 between the evaporation ponds 248, 252 may be similarly constructed.

Gasses that are generated within the bioreactor pond 204, including products of the metabolism of VOCs, may be collected through one or more gas outlets 214 of the bioreactor pond 204. Each gas outlet 214 may communicate with or comprise a conduit that vents gasses and, in some embodiments, transports the gasses to one or more locations where they may be collected or processed. In this embodiment, the vented gasses may be transported to a storage container 256, although the vented gasses may be transported to any number of different locations, containers, or components.

It may be desirable to maintain a flow of liquids within the interior of a bioreactor system (e.g., within bioreactor pond 204 or bioreactor tank 104), or to otherwise condition the wastewater so as to facilitate bioreactive processes. Accordingly, a conditioning system may optionally be provided. The valving stations in FIGS. 1 and 2 represent some examples of conditioning systems. Such systems may provide, for instance, a continuous, occasional or periodic flow of liquids into and out of the interior of a bioreactor. A variety of different types of mixing systems may be employed as will be appreciated by those of ordinary skill in the art. In some embodiments, conditioning systems may also include other components, including heating elements, additive stations, and the like.

Turning now to FIG. 3, a bioreactor system 300 is schematically illustrated and includes an example valving station 328. The valving station 328 is an example of one type of conditioning system that may be used to facilitate treatment of wastewater within the bioreactor system 300.

In this particular system, the valving station 328 is positioned between a feed reservoir 302 and a bioreactor reservoir 304 so as to allow wastewater or other materials within the feed reservoir 302 to pass through the valving station 328 and thereafter into the bioreactor reservoir 304. Optionally, the valving station 328 may also allow materials already within the bioreactor reservoir 304 to be circulated out of the reservoir 304, through the valving station 328, and back into reservoir 304. While reservoirs 302, 304 are schematically illustrated as open reservoirs, it should be appreciated that such an embodiment is merely illustrative. In other embodiments, for instance, the reservoirs 302, 304 may be substantially closed, such as in the case of a tank or a covered pond.

In this embodiment, the feed reservoir 302 includes an outlet 308 through which wastewater or other materials may be fed into the valving station 328. Within the valving station 328 are two pumps 330, 332. According to the illustrated embodiment, the pump 332 may communicate with the outlet 308. The pump 332 is configured to draw fluids from the interior of the feed reservoir 302 and move them to an outlet 358 of the pump 332, which outlet may ultimately lead to an input (e.g., input 310 or 312a) of the bioreactor reservoir 304.

When fluids exit the pump 332 at the outlet 358, the fluid from the feed reservoir 302 may move along any of one or more different paths. In FIG. 3, for instance, the pump outlet 358 may branch or split into two channels or conduits 358a, 358b. Fluid passing through the channel 358a, for instance, may move directly to an input 310 to the bioreactor reservoir 304. In contrast, fluid passing through the channel 358b may follow a different route and pass through additional or other components.

In FIG. 3, for instance, the valving station 328 includes a heating element 360. The heating element 360 may be in-line with the channel 358b. As a result, fluid drawn from the feed reservoir 302 may pass through the pump 332 and into the heating element 360. Such fluid may there be heated to be within a desired temperature range. Thereafter, the fluid can be expelled from the heater 360 through an output channel 362 that leads to an input 312a of the bioreactor reservoir 304.

Including a heating element 360 within the valving station 328 of the present embodiment allows for a variety of actions to take place to enhance the efficiency of the bioreactor system 300. For instance, anaerobic microorganisms such as mesophilic bacteria may digest VOCs and other materials when the wastewater is at a temperature range between 35° F. and 100° F. At the lower end of the spectrum, however, the bacteria may operate at lower efficiency. Digestion of VOCs may be low, and consequently the production of biogas may be low. It may therefore be beneficial to increase the temperature of the wastewater to improve digestion and biogas production.

At times, however, the temperature of the wastewater in the feed reservoir 302 may be suitable for efficient treatment in the bioreactor reservoir 304. In that case, the wastewater may bypass the heating element 360 (e.g., by following output 358a). To bypass the heating element 360, a stop valve 364 on the channel 358b may be activated, so that all flow is diverted to the channel 358a, which flow does not extend through the heating element 360.

As further discussed herein, other aspects of the present disclosure contemplate mixing contents of the bioreactor reservoir 304. Mixing the contents of the bioreactor reservoir 304 may distribute the anaerobic microorganisms throughout the reservoir 304, thereby allowing the microorganisms to find and feed on VOCs and other digestible materials.

The valving station 328 of FIG. 3 also includes a pump 330 that may be solely or primarily used for re-circulating and mixing materials within the bioreactor reservoir 304. In this embodiment, the pump 330 may be in communication with one or more outlets 316, 318 of the bioreactor reservoir 304. Such outlets 316, 318 may provide access to different materials within the reservoir 304. For instance, the outlet 316 may be located at or near the bottom of the reservoir 304, where suction from the pump 330 may pull solid materials and sludge. The outlet 318 may be at an intermediate location on the reservoir 304 so as to allow liquid materials, including wastewater being treated, to be pulled therefrom.

Wastewater and potentially solid materials drawn from the bioreactor reservoir 304 may move through the pump 330 and to an outlet channel 364. The outlet channel 364 may follow a single path or may branch into two or more paths. In FIG. 3 there are two channels 364a, 364b branching from the outlet channel 364, although more or fewer than two branching channels may be available.

As with the outlet channel 358 of the pump 332, the outlet channel 364 may branch into paths, one or more of which may pass through a heating element 360. In this embodiment, the same heating element 360 used for heating materials passing through the pump 332 may also heat materials passing through the pump 330. In other embodiments, separate heating elements may be used.

More particularly, in the illustrated example, the channel 364a may allow pumped materials to pass directly from the pump 330 to an input 312b of the reservoir 304. In contrast, the channel 364b may send materials into the heating element 360. As discussed above, wastewater and other materials may be more effectively treated using some anaerobic microorganisms when the treated materials are in a desired temperature range. Materials within the bioreactor reservoir 304 may be at a temperature below the desired range, or may cool while being re-circulated. In one embodiment, the reservoir 304 may itself act as a heat sink so that heat is drawn out from the wastewater or other materials within the reservoir 304. By passing re-circulated materials through the heating element 360, the wastewater and other materials can be brought to a desired temperature. Materials may exit the heating element 360 through the output channel 362 where they are directed into an input 312a of the bioreactor reservoir 304.

While one pump (i.e., pump 332) may be used as a feed pump for feeding wastewater from the feed reservoir 302 to the bioreactor reservoir 304, and a second pump (i.e., pump 330) may be used to pump and re-circulate materials within the bioreactor reservoir 304, such an embodiment is merely illustrative. In other embodiments, for instance, the same pump may both feed materials to, and re-circulate materials within, the bioreactor reservoir 304.

As an example, FIG. 3 illustrates the outlet 318 of the bioreactor reservoir 304 as potentially branching into two channels 318a, 318b. One channel 318a may feed into one inlet of the pump 330. An optional second channel 318b may feed into one inlet of the pump 332. Thus, each of the pumps 330, 332 optionally include multiple inputs. More particularly, the inputs to the pump 330 may include wastewater and solid material from the bioreactor reservoir 304, while the inputs to the pump 332 may include wastewater from the feed reservoir 302 as well as wastewater from the bioreactor reservoir 304.

When multiple inputs are provided to one or both of the pumps 330, 332, the pumps 330, 332 may simultaneously draw from the multiple sources, or may selectively draw from only a single source. In FIG. 3, the various outputs and channels 308, 316, 318a, 318b leading to the pumps 330, 332 may have respective stop valves 366 thereon. If, for instance, it is desired to use the pump 332 to only feed wastewater from the feed reservoir 302 to the bioreactor reservoir 304, the stop valve 366 on the channel 318b may be used to close the channel 318, thereby allowing suction to only draw from the feed tank 302. Similarly, if the stop valve 366 on the channel 316 is closed, the pump 330 may draw only the wastewater from the bioreactor reservoir 304, without also drawing the sludge or other solid materials. Thus, materials input into the valving station 328 by the pumps 330, 332 may be limited to a single source for each pump. Alternatively, the inputs may allow multiple simultaneous inputs for each pump.

Stop valves 366 may also be positioned on the channels 358a, 358b, 364a, 364b, and used to control the direction and conditioning of the pumped materials. In particular, by closing one valve, materials may be restricted from flowing through the heating element 360, or restricted from bypassing the heating element. By way of illustration, if the stop valve 366 on the channel 358b is closed, the materials (e.g., feed materials from the feed reservoir 302 or re-circulated materials from the bioreactor reservoir 304) may instead flow through the channel 358a and directly to the input 310 of the bioreactor reservoir. A similar effect may be produced by closing the stop valve 366 on channel 364b, in which case re-circulated materials may pass through the channel 364a and into the bioreactor reservoir 304 through input 312b. Conversely, by closing stop valves 366 on channels 358a, 364a and opening the stop valves 366 on the channels 358b, 364b, the pumped materials may be forced through the heating element 360 to be conditioned by heating the materials to a desired temperature. The stop valves 366 may therefore be selectively actuated to direct the flow of materials into the pumps 330, 332 and/or the heating element 360.

As a more particular example, each of the stop valves 366 may be selectively operated and opened or closed in a manner that controls access to, and the destination of, water flowing through the valving station 328. For instance, where the stop valves 366 on channels 308, 318b are each open, the pump 332 may draw from both the feed reservoir 302 and the bioreactor reservoir 304. Such fluids may then be combined and sent to the heater 360 for conditioning, when the stop valve 366 on channel 358b is open. Alternatively, if the stop valve 366 on channel 358b is closed and the stop valve 366 on channel 358a is open, the combined fluids may bypass the heating element 360 and flow through inlet 310 back into the bioreactor reservoir 304. Of course, by selectively closing one or both of the stop valves 366 on channels 308, 318b, the sources of wastewater can be changed. A similar process may also be obtained by selectively closing the stop valves 366 on channels 316, 318a, 364a and 364b with respect to wastewater and/or solid materials pumped by the pump 330.

In some embodiments, an operator of the bioreactor system 300 may want or need to determine the conditions present within the bioreactor reservoir 304 and/or the feed reservoir 302. To assist in such a task, the valving station 328 may also include one or more sampling lines 368a-368c. The illustrated sampling lines 368a-368c may each allow sampling and/or testing of certain materials flowing through the valving station 328. For instance, the sampling line 368a is connected to the output 364a from the re-circulation pump 330, and allows sampling of wastewater, solid materials, or a combination thereof that are re-circulated using the pump 332 and which bypass the heating element 360. Similarly, the sampling line 364b is connected to the output 358a from the pump 332, and allows sampling of untreated wastewater, re-circulated wastewater, or a combination thereof, and which also bypass the heating element 360. In contrast, the sampling line 368c may be connected to the output 362 from the heating element 360. Thus, untreated wastewater from the feed reservoir 302, or re-circulated wastewater and/or solid materials from the bioreactor reservoir 304, or some combination thereof, may be sampled after it is heated using the heating element 360.

Various stop valves 366 on the sampling lines 368a-368c may be used to selectively open and close the sampling lines 368a-368c as needed. When one or more stop valves 366 are opened, materials passing therethrough may be directed to a desired source. In this embodiment, for instance, the sampling lines 368a-368b are directed to a drain 370, although a reservoir, vessel or other element may also be used to receive materials through a sampling line 368a-368c.

As will be appreciated by those skilled in the art in view of the disclosure herein, the valving station 328 may allow an operator of a wastewater treatment facility to effectively and efficiently treat wastewater, even when environmental conditions change. As an example, when wastewater in a bioreactor reservoir 304 and/or feed reservoir 302 are already at a desired temperature (e.g., during warmer times of the day or year), the valving station 328 may allow a heating element 360 to effectively be shut-down so that wastewater bypasses the heating element 360. Conversely, when wastewater is colder (e.g., during colder times of the day or year), the heating element 360 may be selectively activated and the flow of materials may pass through the heating element 360.

The valving station 328 also offers flexibility with respect to when and how materials are moved to or within the bioreactor reservoir 304. As an example, as the illustrated system includes two pumps 330, 332, each pump may be operated at different times, have different capabilities, or serve different purposes. If, for instance, one of the pumps fails, materials may still be re-heated as pumped using the other pump. Materials may be fed or re-circulated by the other pump as well. Moreover, according to some embodiments, pumping of solid materials may require a higher power pump than pumping other materials, such as wastewater from the feed reservoir 302 and/or the bioreactor reservoir 304. A pump (e.g., pump 330) for pumping solid materials may therefore be larger or more powerful than a pump (e.g., pump 332) for pumping materials that are less dense or viscous. By selectively using the lower-powered pump when available, power requirements for the bioreactor system 300 may be reduced.

The example system of FIG. 3 is but one example of a suitable conditioning system that may be used in connection with a bioreactor and/or wastewater treatment facility. In other embodiments, for instance, additional or other components may be provided. A chiller or cooler may be provided where, for instance, it is desirable to reduce a temperature of feed wastewater and/or re-circulated wastewater. Filters, burners, driers, or other components may also or alternatively be provided.

In addition, the valving within a conditioning system may be varied in any manner of different ways. To illustrate one example, FIG. 4 provides a schematic illustration of another bioreactor system 400, which system may be operated in a manner similar to that of the bioreactor system 300 of FIG. 3. In particular, the bioreactor system 400 provides a valving station 428 which can perform the same or similar functions as the valving station 328, but with different valving aspects.

More particularly, a feed reservoir 402 may include an outlet 408 while a bioreactor reservoir 404 includes a plurality of outlets 416, 418. Optionally, one or more of the outlets split into multiple channels or lines (e.g., outlet 418 to outlets 418a, 418b). The various outlets 408, 416, 418 may be directed into a manifold 472. The manifold 472 shown in FIG. 4 may allow the four inputs and can provide two output channels 476a, 476b, each of which leads to a pump 430, 432.

The manifold 472 may act as a valve to determine which inputs communicate with respective pumps 430, 432. For instance, the illustrated manifold 472 may be used to allow one, none or both of the output 408 from the feed reservoir 402 and/or output 418b from the bioreactor reservoir 404 to communicate with the pump 432 (e.g., to allow suction drawing fluid towards the pump 332). Similarly, the manifold 472 may allow one, none, or both of the output 418a carrying re-circulated waste water and/or output 416 carrying re-circulated solid materials to communicate with the pump 430 (e.g., to allow suction drawing fluid or other materials towards the pump 430). The manifold 472 may be operated manually or automatically. For instance, an electronic control system 474 may determine which valves within the manifold 472 should be opened for a desired condition (e.g., that feed materials from the feed reservoir 402 should be the only materials passed to the pump 332 and/or that wastewater and solid materials should be re-circulated using pump 330).

Depending on the conditions set by the manifold 472, the pumps 430, 432 may pump different types of material through corresponding outlets 464, 458, each of which may lead to a second manifold 478. The second manifold 478 may also act as a valve to determine which of different directions inputs should be directed. As shown in FIG. 4, for instance, the output channel 458 may be selectively directed by the manifold 478 to provide fluid to a first output channel 458a which bypasses a heating element 470, or to a second output channel 458b which can be directed to the heating element 470. Similarly, the output channel 464 may pass fluid into the manifold 478 and the manifold 478 determines whether the fluid bypasses the heating element 470 (i.e., is output to channel 464a) or is directed to the heating element 470 (i.e., is output to channel 464b).

Optionally, if two or more channels are to be directed to the heating element 470, and additional valve 480 or manifold may be provided to selectively combine the flow into a single output 482 that is then passed into the heating element 470. Of course, in other embodiments, the heating element 470 may allow multiple inputs or there may be multiple heating elements 470.

Fluids and other materials that pass through the heating element 470, or which bypass the heating element 470, may be directed into the bioreactor reservoir 404. In accordance with one embodiment, such as that in FIG. 3, each channel for a fluid or other material may provide an individual input to the bioreactor reservoir 404. In other embodiments, however, one or more channels may be combined into a single input. FIG. 4, for instance, illustrates an additional valve 484 or manifold which can be used to combine the flow from multiple channels. In particular, the valve 484 may receive materials from the channels 458a, 464a which include materials pumped by pumps 432 and 430, respectively, and which bypass the heating element 470. Additionally, or alternatively, the valve 484 may include an input from the channel 462 which originates from the heating element 470. Any or all flows may combine within the valve 484 and be directed to an output 486 which connects to an input 410 of the bioreactor reservoir 404.

Sampling lines 468a-468c and corresponding stop valves 466 may also be connected to various output channels, and can optionally lead to a drain 471. The operation of the sampling lines 468a-468c may be similar to that of the sampling lines described in FIG. 3. In other embodiments, however, rather than including individual stop valves 466, a sampling manifold (not shown) may be used to provide collective control over the sampling lines 468a-468c.

Those skilled in the art will appreciate, in view of the disclosure herein, that the system 400 may provide centralized control of the operation of one or more aspects of the valving station 428. In particular, rather than operating each output or fluid line individually, one or more manifolds or valves may collectively control which fluids are drawn and/or the direction drawn fluids travel. Thus, if a system operator wants to draw only fluid from the feed tank 402, the manifolds and valves within the valving station 428 can automatically or manually be set to do so, optionally with the ability to also control whether or to what extent certain conditioning (e.g., heating) occurs. Similar control may be used to determine which pump handles transfer of fluids and/or whether multiple fluids can be transferred simultaneously.

Moreover, although aspects of the present disclosure include a valving station 428 which is between the feed reservoir 402 and the bioreactor reservoir 404, this should not be interpreted as requiring the valving station 428 have any particular physical location. Instead, the valving station 428 may be between the feed reservoir 402 and the bioreactor reservoir 404 in terms of fluid flow, such as when downstream from the feed reservoir 402 and upstream relative to the bioreactor reservoir 404. In some embodiments, the valving station 428 may even be physically formed as part of the feed reservoir 402 or the bioreactor reservoir 404, with components in multiple physical locations, at an off-site location, or in other manners.

With continued reference to FIG. 4, various elements of a method for treating wastewater (in addition to those that should already be apparent from the foregoing description) and maintaining wastewater at a desired temperature are now described. Such method may be fully or partially performed at a wastewater treatment facility using either a large-scale bioreactor system (e.g., bioreactor system 200) or a smaller scale system (e.g., bioreactor system 100). Additionally, while described in the context of the bioreactor system 400 of FIG. 4, the method may also be performed in the bioreactor system 300 of FIG. 3, or any other way, regardless of the environment in which the bioreactor system is situated.

Initially, wastewater may be provided (e.g., through a tanker, at the location of the treatment facility, etc.). Wastewater that is provided may be accessed and LNAPLs and, optionally, sludge may be separated from the wastewater. Separation may be achieved by any suitable means, including using a separator, skim pond, or other component described herein or known in the art. Separation may be effected by gravity, centrifugation or any other suitable technique. Separation may, for instance, occur in a separator over a sufficient period of time (e.g., a few hours, a few days, etc.) to enable LNAPLs (e.g., oil, gas, other hydrocarbons, etc.) that have mixed with the wastewater to separate from the wastewater. Once LNAPLs have separated from the wastewater, they may be removed and optionally stored. In addition to allowing LNAPLs to separate from the wastewater, sludge (e.g., DNAPLs, solids, etc.) may drop to the bottom of the separator while the wastewater sits therein. The solids, which may be referred to as “sludge,” may be periodically or occasionally collected.

Following the initial, rough separation of LNAPLs and sludge from the wastewater, as well as any optional flaring, further separation of LNAPLs and/or sludge from the wastewater may occur. In some embodiments, the wastewater may reside within the feed reservoir 402, which may act as a skim pond in some embodiments. The water may reside for a prolonged period of time, and any LNAPLs that collect at the surface of the wastewater may be collected and potentially stored. Any solids that drop to the bottom of the feed reservoir 402 may remain there until the solids, or sludge, is removed. The recovered sludge may be used for other purposes; for example, to form hardened roadway surfaces (e.g., at oil or gas exploration or production facilities, etc.).

The wastewater in the feed reservoir 402 may be accessed and may be examined to determine whether or not it is suited for introduction into the bioreactor reservoir 404 (e.g., to determine if sufficient separation has been achieved and LNAPLs have been removed), or to determine how it should be introduced into the bioreactor reservoir 404. As an example of such examination, the wastewater may be tested for the presence of biocides, which are sometimes added to water used during exploration and/or production. If undesirably high levels of biocides are detected (e.g., sufficient levels to disturb the anaerobic microorganisms of the bioreactor reservoir 404, etc.), the wastewater may bypass the bioreactor reservoir 404 and proceed to alternative treatment components. As another example, if the salt and/or TDS content of the wastewater is undesirably high (e.g., at or above a level that would have a detrimental effect on the anaerobic microorganisms), the volume of wastewater introduced into the bioreactor reservoir 404 may be limited (e.g., to an amount that will not increase the salt or TDS content of the wastewater by more than a fixed amount (e.g., five percent, ten percent, etc.) until wastewater with a lower salt or TDS content is available). Alternatively, fresher water may be added to wastewater with a high salt content or TDS content to dilute the same. As another alternative, such wastewater may bypass the bioreactor reservoir 404.

In some embodiments, other characteristics of the wastewater may be determined. For instance, a temperature of the wastewater may be measured. If the temperature is too low or environmental or other considerations indicate that the wastewater may be undesirably cool, the wastewater may be heated. Conversely, if the temperature is too high, the wastewater may be chilled or cooled. To perform such a function, the valving station 428 may use manifold 472 as a valve to open flow from the feed reservoir 402 to a pump 432. Untreated wastewater from the feed reservoir 402 may pass from the pump 432 to a fluid output 458, and to a second manifold 478. The second manifold 478 may also act as a valve to determine whether the untreated wastewater should be directed to a heating element 460, or should bypass the heating element 460. When the manifold 478 opens the conduit to the heating element 460, the untreated wastewater may be heated to a desired temperature. Thereafter, the heated, untreated wastewater may be output along a channel 462 and ultimately to an input 410 to the bioreactor reservoir. As noted previously, one or more additional manifolds or valves (e.g., valves 480, 484) and channels (e.g., channels 482, 486) may also be used to convey the untreated wastewater to a heating element and/or to the bioreactor reservoir 404. At the bioreactor reservoir, anaerobic microorganisms may then be used to treat the wastewater and reduce a content of VOCs in the wastewater.

Alternatively, if the temperature or other condition of the wastewater obtained from the feed reservoir 402 is satisfactory, the heating element 460 and/or other conditioning element may be bypassed. In FIG. 4, for instance, the manifold 478 may open a valve to channel 464a and close a valve to channel 464b, thus allowing the unconditioned wastewater to flow through the valve 484 and channel 486 to the input 410 to the bioreactor reservoir.

In addition to, or instead of, feeding wastewater from the feed reservoir 402 to the bioreactor reservoir 404, wastewater and/or sludge in the bioreactor reservoir 404 may be re-circulated and optionally conditioned. As an example, in some embodiments, a temperature or other characteristic of the wastewater may be determined or assumed. If the temperature is too low or the environmental conditions suggest the wastewater may be undesirably cold, the wastewater may be heated, whereas if the temperature is too high, the wastewater may be chilled or cooled. To perform such a function, the valving station 428 may use the manifold 472 as a valve to open flow from the bioreactor reservoir 404 to the pump 432. If the manifold closes the channel to the feed reservoir 402, the treated wastewater may be pumped through the system as previously described, such that re-circulated, treated wastewater may be selectively conditioned or may bypass conditioning. If both valves (i.e., the valves to the feed reservoir 402 and to the bioreactor reservoir 404) are open, the wastewater may be combined when either being conditioned (e.g., treated by heating element 470) or not.

Alternatively, rather than using the pump 430, the untreated wastewater from the bioreactor reservoir 404 may be moved by the pump 430. In particular, wastewater and/or sludge may be transferred by the pump 430, depending on whether the manifold 470 opens or closes valves corresponding to the channels 416, 418a. The wastewater and/or sludge may then be conveyed by the pump 430 and output to a channel 464. The second manifold 478 may then control whether the wastewater and/or sludge output in channel 464 should be directed to or around the heating element 460. If the heating element is to be used (e.g., to heat or maintain a temperature of the wastewater), the manifold 478 may open a corresponding valve leading to a channel 464b, and ultimately to the heating element 460 as described above. Alternatively, if the heating element is not to be used (e.g., the temperature is already sufficiently high, the sludge or material is too viscous for the heating element 460, etc.), the manifold 478 may close a valve leading to the channel 464b and open a channel 464a leading through a valve 484 and to the input 410 to the bioreactor reservoir 404.

Using the above method, the temperature of the wastewater being treated in the bioreactor reservoir 404 may be maintained at a desired temperature, whether by heating untreated wastewater from the feed reservoir 402, heating re-circulated wastewater or sludge from the bioreactor reservoir 404, or both. Moreover, such a system may use the same heating element to selectively heat either or both components, although in other embodiments different heaters may be used. By maintaining the temperature within a desired range, the anaerobic microorganisms in the bioreactor reservoir 404 may operate at a more effective level to break down VOCs and/or to produce high grades of biogas. All or substantially all gases and vapors that are present within the bioreactor reservoir 404 may be removed therefrom, creating a substantially or totally anaerobic environment. Gasses may be continually drawn, or drawn when exceeding a desired pressure, and released or stored (e.g., in a separate storage container). In some embodiments, the produced biogas may include different elements or compounds as produced by different microorganisms or by the digestion of different VOCs or other materials. According to one embodiment, for instance, two or more gasses (e.g., methane and carbon dioxide) may be produced in different relative proportions by weight and/or volume (e.g., 80/20, 70/30, 60/40, etc) although the compounds may also be produced in relatively equal proportions.

According to various embodiments, metabolism of VOCs and/or production of biogas may slow, even in embodiments in which the temperature is maintained at desired levels. In such cases, the bioreactor system 400 may receive a catalyst or other elements to enhance or boost effectiveness. As an example, additional microorganisms may be introduced into the bioreactor reservoir 404 (e.g., prior to or during feeding in additional wastewater from the feed reservoir 402). In addition or as an alternative, VOCs or materials that can be metabolized and digested by the anaerobic microorganisms may be added. For instance, where methanol is metabolized by the anaerobic microorganisms, a quantity of methanol may be added to the bioreactor reservoir 404 (e.g., prior to or during feeding of wastewater from the feed reservoir 402) to stabilize the conditions in the bioreactor reservoir 404 and/or improve activity of the anaerobic microorganisms.

Although the foregoing description contains many specifics, these should not be construed as limiting the scopes of the inventions recited by any of the appended claims, but merely as providing information pertinent to some specific embodiments that may fall within the scopes of the appended claims Features from different embodiments may be employed in combination. In addition, other embodiments of the invention may also lie within the scopes of the appended claims All additions to, deletions from and modifications of the disclosed subject matter that fall within the scopes of the claims are to be embraced by the claims

What is claimed:

1. A wastewater treatment facility, comprising:
a feed reservoir containing wastewater;
a bioreactor reservoir positioned to receive the wastewater from the feed reservoir and to remove organic compounds from the wastewater; and
a valving station between the feed reservoir and the bioreactor reservoir, the valving station comprising:
one or more pumps;
a wastewater conditioning element; and
one or more valves for using the one or more pumps to selectively pass to the wastewater conditioning element wastewater from the feed reservoir or wastewater re-circulated in the bioreactor reservoir.

2. The wastewater treatment facility of claim 1, wherein the valving station is positioned between a wastewater outlet of the feed reservoir and a wastewater inlet of the bioreactor reservoir.

3. The wastewater treatment facility of claim 1, wherein the valving station is positioned between a wastewater outlet of the bioreactor reservoir and a wastewater inlet of the bioreactor reservoir.

4. The wastewater treatment facility of claim 1, wherein the one or more pumps includes at least two pumps.

5. The wastewater treatment facility of claim 4, wherein:
a first pump is connected to the feed reservoir and the bioreactor reservoir for transferring wastewater from the feed reservoir to the bioreactor reservoir; and
a second pump is connected to the bioreactor reservoir for re-circulating wastewater in the bioreactor reservoir.

6. The wastewater treatment facility of claim 1, wherein a first pump of the one or more pumps is connected to an outlet of the feed reservoir and to an outlet of the bioreactor, and wherein the one or more valves are configured to selectively use the first pump to transfer wastewater from the feed reservoir to the bioreactor reservoir and to re-circulate wastewater in the bioreactor reservoir.

7. The wastewater treatment facility of claim 1, wherein a first pump of the one or more pumps is connected to two outlets of the bioreactor reservoir, the two outlets corresponding to a wastewater outlet and a solid materials outlet.

8. The wastewater treatment facility of claim 1, wherein the wastewater conditioning element is a heater.

9. The wastewater treatment facility of claim 1, wherein the one or more valves are configured to allow wastewater from the feed reservoir or re-circulated wastewater in the bioreactor reservoir to selectively bypass the wastewater conditioning element.

10. The wastewater treatment facility of claim 1, wherein the feed reservoir is a moveable tank.

11. The wastewater treatment facility of claim 1, wherein the feed reservoir is a skim pond.

12. The wastewater treatment facility of claim 11, further comprising one or more evaporation ponds downstream from the bioreactor reservoir.

13. The water treatment facility of claim 1, wherein the valving station includes one or more sampling lines, the one or more sampling lines including:
a sampling line for sampling output of the wastewater conditioning element;
a sampling line for sampling output of the feed reservoir which bypasses the wastewater conditioning element; or
a sampling line for sampling re-circulated wastewater of the bioreactor reservoir which bypasses the wastewater conditioning element.

14. A method for treating wastewater and maintaining the wastewater at a desired temperature, comprising:
accessing untreated wastewater from a feed reservoir;
transferring the wastewater from the feed reservoir to a bioreactor reservoir for mixing with treated wastewater and anaerobic microorganisms in the treated wastewater;
conditioning one or more of the untreated and treated wastewater such that:
when the untreated wastewater is being conditioned, the untreated wastewater is selectively transferred to a conditioning element after being output from the feed reservoir and prior to being input to the bioreactor reservoir; and
when the treated wastewater is being conditioned, the treated wastewater is re-circulated and selectively transferred to the conditioning element and thereafter re-input into the bioreactor reservoir; and
treating the untreated wastewater with the anaerobic microorganisms to reduce a content of volatile organic compounds dissolved in the untreated wastewater.

15. The method of claim 14, wherein conditioning one or more of the untreated and treated wastewater includes using a heater as the conditioning element.

16. The method of claim 14, wherein conditioning one or more of the untreated and treated wastewater includes using one or more valves for selectively conditioning the untreated and treated wastewater using the same conditioning element.

17. The method of claim 14, further comprising:
transporting the untreated wastewater to a wastewater treatment site where the feed reservoir is located or accessed.

18. The method of claim 14, further comprising:
adding anaerobic microorganisms to the bioreactor reservoir.

19. The method of claim 14, further comprising:
adding organic materials to the treated wastewater, the organic materials being digestible by the anaerobic microorganisms.

20. The method of claim 19, the added organic materials including methanol.

21. The method of claim 14, further comprising:
releasing gas from the bioreactor reservoir, the released gas including gas generated by the anaerobic microorganisms metabolizing the volatile organic compounds.

22. The method of claim 21, wherein releasing gas from the bioreactor reservoir includes collecting the gas in a storage container.

23. A wastewater treatment facility, comprising:
a feed reservoir having a fluid outlet;
a bioreactor reservoir downstream from the feed reservoir, the bioreactor reservoir including at least one input, a fluid output, and a solid materials output; and
a valving station downstream from the feed reservoir and upstream from the bioreactor reservoir, the valving station including:
a first pressure element for receiving fluid from the fluid outlet of the feed reservoir and transferring the fluid output to the at least one input of the bioreactor reservoir;
a second pressure element for receiving fluid from the fluid and solid materials outlets of the bioreactor reservoir and re-introducing the fluid and solid materials to the bioreactor reservoir through the at least one input of the bioreactor reservoir;
a heater downstream relative to the first and second pressure elements and upstream relative to the input of the bioreactor reservoir; and
one or more valves for selecting whether output of the first and second pressure elements is delivered to, or bypasses, the heater.

24. The wastewater treatment facility of claim 23, wherein the first and second pressure elements include a gravity feed or a pump.

25. The wastewater treatment facility of claim 23, wherein the first pressure element is a pump configured to selectively receive fluid from each of the feed reservoir and the bioreactor reservoir, while the second pressure element is a pump configured to selectively receive fluid and solid materials from the bioreactor reservoir but not the feed reservoir.
